(19) United States
(12) Patent Application Publication
(10) Pub. No.: US 2018/0276542 A1
(43) Pub. Date: Sep. 27, 2018

(54) Recommendation Result Generation Method and Apparatus

(71) Applicant: Huawei Technologies Co., Ltd., Shenzhen (CN)

(72) Inventors: Jiefeng Cheng, Shenzhen (CN); Zhenguo Li, Hong Kong (CN); Xiuqiang He, Shenzhen (CN); Dahua Lin, Hong Kong (CN)

(21) Appl. No.: 15/993,288

(22) Filed: May 30, 2018

Related U.S. Application Data
(63) Continuation of application No. PCT/CN2017/092828, filed on Jul. 13, 2017.

(30) Foreign Application Priority Data
Nov. 22, 2016 (CN) 201611043770.X

(51) Int. Cl. G06N 3/08; G06N 3/04

(52) U.S. Cl. CPC G06N 3/08; G06N 3/04

(57) ABSTRACT

A recommendation result generation method, where the method includes obtaining article content information of at least one article and user score information of at least one user, where user score information of a first user of the at least one user includes a historical score of the first user for the at least one article, encoding the article content information and the user score information using an article neural network and a user neural network respectively to obtain a target article latent vector of each of the at least one article and a target user latent vector of each of the at least one user, and calculating a recommendation result for each user according to the article latent vector and the user latent vector.

### CROSS-REFERENCE TO RELATED APPLICATIONS

This application is a continuation of International Patent Application No. PCT/CN2017/092828 filed on Jul. 13, 2017, which claims priority to Chinese Patent Application No. 201611043770.X filed on Nov. 22, 2016. The disclosures of the aforementioned applications are hereby incorporated by reference in their entireties.

### TECHNICAL FIELD

Embodiments of this application relate to the field of electronic services, and in particular, to a recommendation result generation method and apparatus.

### BACKGROUND

As networks and electronic business platforms rapidly develop in the last decade, massive business data, such as user information, article information, and score information is generated. An article that a user likes may be predicted and recommended to the user by analyzing the data. Recommendation algorithms have been widely applied to business systems such as AMAZON and NETFLIX, and huge profits are generated.

Recommendation result generation methods mainly include content-based recommendation, collaborative filtering-based recommendation, and hybrid recommendation. Content-based recommendation mainly depends on characteristic representation of content, and a recommendation list is generated in descending order of characteristic similarity degrees. Based on this method, in some work, supplementary information (for example, metadata of a user) is added to improve recommendation accuracy. Collaborative filtering-based recommendation, an interaction relationship between a user and an article is used. According to a common collaborative filtering method, implicit information of a user and implicit information of an article are obtained by means of matrix factorization, and a matching degree between the user and the article is calculated using a dot product of the implicit information of the user and the implicit information of the article. Researches show that collaborative filtering-based recommendation usually has higher accuracy than content-based recommendation does. This is because collaborative filtering-based recommendation directly targets a recommendation task. However, this method is usually restrained by a cold start problem in practice. If there is insufficient user history information, it is very difficult to precisely recommend an article. These problems motivate researches on hybrid recommendation systems, and a better recommendation effect can be obtained by combining information of different aspects. However, in conventional hybrid recommendation, there are still problems such as insufficient characteristic expressiveness and an undesirable recommendation capability for a new article.

Collaborative deep learning (CDL) is a representative method in existing hybrid recommendation result generation methods. According to this method, a stacked denoising autoencoder (SDAE) encodes article content information to obtain an initial article latent vector, the article latent vector is combined with a scoring matrix, and a final article latent vector and a final user latent vector are obtained by means of optimization. However, in the CDL method, user representation is still obtained by means of matrix factorization. As a result, a user latent vector is insufficiently expressive, and a final recommendation result is not sufficiently precise.

### SUMMARY

In view of this, embodiments of this application provide a recommendation result generation method and apparatus to improve accuracy of a recommendation result.

According to a first aspect, a recommendation result generation method is provided, including obtaining article content information of at least one article and user score information of at least one user, where user score information of a first user of the at least one user includes a historical score of the first user for the at least one article, encoding the article content information and the user score information using an article neural network and a user neural network respectively to obtain a target article latent vector of each of the at least one article and a target user latent vector of each of the at least one user, and calculating a recommendation result for each user according to the target article latent vector and the target user latent vector.

First, the article content information of the at least one article and score information of the at least one user for the at least one article may be obtained. Optionally, the score information may be in a form of a matrix. Subsequently, the article content information and the user score information are encoded using the article neural network and the user neural network respectively to obtain the target article latent vector corresponding to the at least one article and the target user latent vector corresponding to the at least one user. Finally, the recommendation result is calculated according to the target article latent vector and the target user latent vector.

Optionally, calculating a recommendation result according to the target article latent vector and the target user latent vector includes calculating a dot product of the target article latent vector and the target user latent vector. For a specific user, a dot product of a user latent vector of the user and each article latent vector is calculated, calculation results are sorted in descending order, and an article that ranks at the top is recommended to the user. This is not limited in this embodiment of this application.

It should be noted that the article neural network and the user neural network may be referred to as dual networks based on collaborative deep embedding (CDE). However, this is not limited in this embodiment of this application.

According to the recommendation result generation method in this embodiment of this application, the article content information and the user score information are encoded using the article neural network and the user neural network respectively to obtain the target article latent vector and the target user latent vector to calculate the recommendation result. In this way, the article content information and the user score information can be fully utilized to improve accuracy of a recommendation result to improve user experience.

In a first possible implementation of the first aspect, N layers of perceptrons are used as a basic architecture of the article neural network and the user neural network, and both the article neural network and the user neural network have N layers, and encoding the article content information and the user score information using an article neural network and a user neural network respectively to obtain a target article latent vector of each of the at least one article and a target user latent vector of each of the at least one user includes encoding the article content information and the user score information at the first layer of the article neural network and the first layer of the user neural network, to obtain a first article latent vector and a first user latent vector, transferring the first article latent vector and the first user latent vector to the second layer of the article neural network and the second layer of the user neural network respectively to perform encoding, encoding a (k−1)^{th} article latent vector and a (k−1)^{th} user latent vector at a k^{th} layer of the article neural network and a k^{th} layer of the user neural network respectively to obtain a k^{th} article latent vector and a k^{th} user latent vector, transferring the k^{th} article latent vector and the k^{th} user latent vector to a (k+1)^{th} layer of the article neural network and a (k+1)^{th} layer of the user neural network respectively to perform encoding, encoding an (N−1)^{th} article latent vector and an (N−1)^{th} user latent vector at an N^{th} layer of the article neural network and an N^{th} layer of the user neural network respectively to obtain an N^{th} article latent vector and an N^{th} user latent vector, and setting the N^{th} article latent vector and the N^{th} user latent vector as the target article latent vector and the target user latent vector respectively, where N is an integer greater than or equal to 1, and k is an integer greater than 1 and less than N.

In this way, because previous information can be refined at a higher layer of a neural network, more effective information can be generated, and accuracy of a recommendation result is improved.

With reference to the foregoing possible implementation of the first aspect, in a second possible implementation of the first aspect, encoding the article content information and the user score information at the first layer of the article neural network and the first layer of the user neural network to obtain a first article latent vector and a first user latent vector includes performing linear transformation on the article content information and the user score information at the first layer of the article neural network and the first layer of the user neural network respectively, and performing nonlinear transformation respectively on the article content information and the user score information on which linear transformation has been performed to obtain the first article latent vector and the first user latent vector.

The article content information and the user score information may be processed at the first layer of the multiple layers of perceptrons in two steps. First, performing linear transformation on the article content information and the user score information respectively, and next, performing nonlinear transformation on the article content information and the user score information respectively on which linear transformation has been performed to obtain the first article latent vector and the first user latent vector.

It should be noted that, the user score information is usually a high-dimensional sparse vector, and the high-dimensional sparse vector needs to be transformed into a low-dimensional dense vector by performing linear transformation at the first layer of the user neural network. In addition, at each layer of the multiple layers of perceptrons, linear transformation may be first performed, and nonlinear transformation may be subsequently performed on inputted information. This is not limited in this embodiment of this application.

With reference to the foregoing possible implementation of the first aspect, in a third possible implementation of the first aspect, a tan h function is used as a nonlinear activation function at each layer of the article neural network and each layer of the user neural network.

With reference to the foregoing possible implementation of the first aspect, in a fourth possible implementation of the first aspect, the method further includes obtaining newly added user score information of a second user of the at least one user, where the newly added user score information is a newly added score of the second user for a first article of the at least one article, updating user score information of the second user according to the newly added user score information, re-encoding the updated user score information of the second user using the user neural network, to obtain a new target user latent vector, and calculating a new recommendation result for each user according to the target article latent vector and the new target user latent vector.

With reference to the foregoing possible implementation of the first aspect, in a fifth possible implementation of the first aspect, the method further includes obtaining article content information of a newly added article, encoding the article content information of the newly added article using the article neural network to obtain a target article latent vector of the newly added article, and calculating a recommendation result for each user according to the target article latent vector of the newly added article and the target user latent vector.

With reference to the foregoing possible implementation of the first aspect, in a sixth possible implementation of the first aspect, the method further includes obtaining newly added user score information of a third user of the at least one user, where the newly added user score information is score information of the third user for the newly added article, updating user score information of the third user for a second article of the at least one article, where a target article latent vector of the second article and the target article latent vector of the newly added article are most similar, re-encoding updated user score information of the third user using the user neural network to obtain a new target user latent vector, and calculating a new recommendation result for each user according to the target article latent vector and the new target user latent vector.

Further, when a new article and/or new user score information is added to a system, a corresponding recommendation result may be obtained using the newly added information on the dual networks. Further, there may be the following three cases.

(1) Score information of a user for a known article is added. In this case, score information of the user needs to be directly updated, and re-encoding is performed using the user neural network that has been trained to recalculate a recommendation result.

(2) A new article is added. In this case, article content information of the newly added article needs to be obtained, and the article content information of the newly added article is encoded using the article neural network that has been trained to obtain a target article latent vector of the newly added article to recalculate a recommendation result.

(3) Score information of a user for the newly added article is added. In this case, the target article latent vector of the newly added article needs to be first obtained, and score information of an article of known articles is subsequently updated, where a latent vector of the article and a latent vector of the newly added article are most similar to perform re-encoding for the user according to new score information to calculate a recommendation result.

With reference to the foregoing possible implementation of the first aspect, in a seventh possible implementation of the first aspect, before obtaining the article content information of at least one article and user score information of at least one user, the method further includes pre-training the article neural network using an encoding result of a stacked autoencoder SDAE, and pre-training the user neural network using a random parameter.

With reference to the foregoing possible implementation of the first aspect, in an eighth possible implementation of the first aspect, before obtaining the article content information of at least one article and user score information of at least one user, the method further includes performing optimization training on the article neural network and the user neural network using a mini-batch dual gradient descent method.

Further, before the recommendation result is obtained, the article neural network and the user neural network may be first trained. A collaborative training method is used in this embodiment of this application, and includes two steps of pre-training and optimization. In a pre-training process, the article neural network is pre-trained using an encoding result of a stacked autoencoder SDAE, and the user neural network is pre-trained using a random parameter. In an optimization process, optimization training is performed on the article neural network and the user neural network using a mini-batch dual gradient descent method.

In this way, two groups of gradients are obtained respectively for an article and a user using a loss value obtained using a target function, and the two groups of gradients are transferred back to corresponding networks respectively. Due to a multilayer interaction network design, training of each network affects another network, and two neural networks are simultaneously trained using a collaborative network training algorithm to improve optimization efficiency.

With reference to the foregoing possible implementation of the first aspect, in a ninth possible implementation of the first aspect, performing the optimization training on the article neural network and the user neural network using a mini-batch dual gradient descent method includes calculating a dot product of a p^{th} article latent vector and a p^{th} user latent vector as an output result of a p^{th}-layer perceptron of the N layers of perceptrons, where p is an integer greater than or equal to 1 and less than or equal to N, combining output results of all of the N layers of perceptrons, and optimizing network parameters of the article neural network and the user neural network by comparing the output results with the user score information.

Further, for each layer of the multiple layers of perceptrons, an output result may be generated. For example, for a p^{th} layer, a dot product of a p^{th} article latent vector and a p^{th} user latent vector is calculated as an output result of the p^{th} layer. In this way, output results of all layers may be combined to optimize the network parameters.

It should be noted that, encoding results of different layers of the multiple layers of perceptrons are complementary. In one aspect, a vector generated at a lower layer close to an input end may retain more information. In another aspect, information may be refined at a higher layer of a neural network. In this way, a generated vector is usually more effective. Therefore, complementarity may be used by coupling multiple layers to effectively improve prediction precision.

Optionally, combining output results of all of the N layers of perceptrons includes adding the output results of all the layers of perceptrons.

With reference to the foregoing possible implementation of the first aspect, in a tenth possible implementation of the first aspect, a target function of the optimization training is

$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} ,$$

where R_{m×n} is a scoring matrix generated according to the user score information, and is used to indicate a score of each of m users for each of n articles, Rᵢⱼ is score information of an i^{th} user for a j^{th} article, xⱼ is content information of the j^{th} article, f is the article neural network, g is the user neural network, Wᵥ is a parameter of the article neural network, Wᵤ is a parameter of the user neural network, vⱼ=f(xⱼ;Wᵥ) is an article latent vector of the j^{th} article, uᵢ=g(V·r̅ᵢ;Wᵤ) is a user latent vector of the i^{th} user, rᵢ is a column vector generated using an i^{th} row of R_{m×n}, r̅ᵢ is a unit vector obtained using rᵢ, R̅ᵢⱼ is a j^{th} element in r̅ᵢ, V=f(X;Wᵥ), X is a matrix formed by article content information of the n articles, m, n, i, and j are all integers greater than or equal to 1, i is greater than or equal to 1 and is less than or equal to m, and j is greater than or equal to 1 and is less than or equal to n.

Further, it is assumed that there are m users and n articles, and i and j are respectively used to indicate indexes. xⱼ is used to indicate content information of a j^{th} article. A scoring matrix R_{m×n} includes historical information of scores of all known users for articles. When Rᵢⱼ is 1, it indicates that there is a positive relationship between an i^{th} user and the j^{th} article. When Rᵢⱼ is 0, it indicates that there is a negative relationship between an i^{th} user and the j^{th} article, or that a relationship between an i^{th} user and the j^{th} article is unknown. In this embodiment of this application, latent vectors having a same dimension are obtained for a user and an article respectively by means of encoding using the article content information X and the scoring matrix R_{m×n}, a latent vector of each user is uᵢ=g(Vrᵢ;Wᵤ), and a latent vector of each article is vⱼ=f(xⱼ/Wᵥ). Finally, a dot product of the user latent vector and the article latent vector is calculated, and a calculated result is compared with an actual value Rᵢⱼ to optimize the network parameters.

According to a second aspect, a recommendation result generation apparatus is provided, and is configured to perform the method in the first aspect or any possible implementation of the first aspect. Further, the apparatus includes units configured to perform the method in the first aspect or any possible implementation of the first aspect.

According to a third aspect, a recommendation result generation apparatus is provided. The apparatus includes at least one processor, a memory, and a communications interface. The at least one processor, the memory, and the communications interface are all connected using a bus. The memory is configured to store a computer executable instruction. The at least one processor is configured to execute the computer executable instruction stored in the memory such that the apparatus can exchange data with another apparatus using the communications interface to perform the method in the first aspect or any possible implementation of the first aspect.

According to a fourth aspect, a computer readable medium is provided, and is configured to store a computer program. The computer program includes an instruction used to perform the method in the first aspect or any possible implementation of the first aspect.

### BRIEF DESCRIPTION OF DRAWINGS

FIG. 1 is a schematic flowchart of a recommendation result generation method according to an embodiment of this application;

FIG. 2 is a schematic flowchart of another recommendation result generation method according to an embodiment of this application;

FIG. 3 is a schematic block diagram of a recommendation result generation apparatus according to an embodiment of this application; and

FIG. 4 is a schematic block diagram of a recommendation result generation apparatus according to an embodiment of this application.

### DESCRIPTION OF EMBODIMENTS

The following describes the technical solutions in the embodiments of this application with reference to the accompanying drawings in the embodiments of this application.

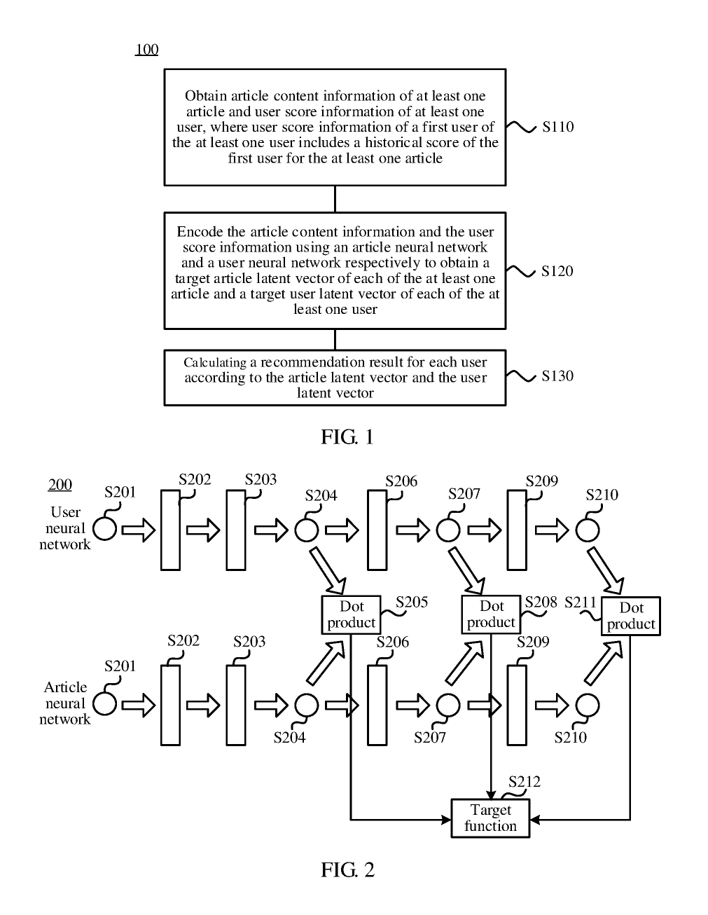

FIG. 1 is a schematic flowchart of a recommendation result generation method 100 according to an embodiment of this application. The method 100 in this embodiment of this application may be implemented by any computing node, and this is not limited in this embodiment of this application.

Step S110: Obtain article content information of at least one article and user score information of at least one user, where user score information of a first user of the at least one user includes a historical score of the first user for the at least one article.

Step S120: Encode the article content information and the user score information using an article neural network and a user neural network respectively to obtain a target article latent vector of each of the at least one article and a target user latent vector of each of the at least one user.

Step S130: Calculate a recommendation result for each user according to the target article latent vector and the target user latent vector.

First, the article content information of the at least one article and score information of the at least one user for the at least one article may be obtained. Optionally, the score information may be in a form of a matrix. Subsequently, the article content information and the user score information are encoded using the article neural network and the user neural network respectively to obtain the target article latent vector corresponding to the at least one article and the target user latent vector corresponding to the at least one user. Finally, the recommendation result is calculated according to the target article latent vector and the target user latent vector.

Optionally, calculating a recommendation result according to the target article latent vector and the target user latent vector includes calculating a dot product of the target article latent vector and the target user latent vector. For a specific user, a dot product of a user latent vector of the user and each article latent vector is calculated, calculation results are sorted in descending order, and an article that ranks at the top is recommended to the user. This is not limited in this embodiment of this application.

The article neural network and the user neural network may be referred to as dual networks based on CDE. However, this is not limited in this embodiment of this application.

It should be noted that, in the foregoing method, dual embedding and a nonlinear deep network are used, and the article content information and the user score information are encoded respectively to obtain the target article latent vector and the target user latent vector.

According to a CDL method, an SDAE encodes article content information to obtain an initial article latent vector, the article latent vector is combined with a scoring matrix, and a final article latent vector and a final user latent vector are obtained by means of optimization. However, in the CDL method, user representation is still obtained by means of matrix factorization. As a result, a user latent vector is insufficiently expressive, and a final recommendation result is not sufficiently precise.

However, in this embodiment of this application, the article content information and the user score information are encoded using the article neural network and the user neural network respectively to obtain the target article latent vector and the target user latent vector to calculate the recommendation result. In this way, the article content information and the user score information can be fully utilized to improve accuracy of a recommendation result to improve user experience.

In an optional embodiment, N layers of perceptrons are used as a basic architecture of the article neural network and the user neural network, and both the article neural network and the user neural network have N layers.

Encoding the article content information and the user score information using an article neural network and a user neural network respectively to obtain a target article latent vector of each of the at least one article and a target user latent vector of each of the at least one user includes encoding the article content information and the user score information at the first layer of the article neural network and the first layer of the user neural network to obtain a first article latent vector and a first user latent vector, transferring the first article latent vector and the first user latent vector to the second layer of the article neural network and the second layer of the user neural network respectively to perform encoding, encoding a (k−1)^{th} article latent vector and a (k−1)^{th} user latent vector at a k^{th} layer of the article neural network and a k^{th} layer of the user neural network respectively to obtain a k^{th} article latent vector and a k^{th} user latent vector, transferring the k^{th} article latent vector and the k^{th} user latent vector to a (k+1)^{th} layer of the article neural network and a (k+1)^{th} layer of the user neural network respectively to perform encoding, encoding an (N−1)^{th} article latent vector and an (N−1)^{th} user latent vector at an N^{th} layer of the article neural network and an N^{th} layer of the user neural network respectively to obtain an N^{th} article latent vector and an N^{th} user latent vector, and setting the N^{th} article latent vector and the N^{th} user latent vector as the target article latent vector and the target user latent vector respectively, where N is an integer greater than or equal to 1, and k is an integer greater than 1 and less than N.

Further, a multilayer perceptron may be used as a basic architecture of the dual networks, and transferred information is encoded at each layer of the article neural network and each layer of the user neural network respectively. For example, both the article neural network and the user neural network have N layers. In this case, the obtained article content information and the obtained user score information are encoded at the first layer of the article neural network and the first layer of the user neural network respectively to obtain the first article latent vector and the first user latent vector. Subsequently, encoding results, that is, the first article latent vector and the first user latent vector, are transferred to the second layer of the article neural network and the second layer of the user neural network respectively, and the first article latent vector and the first user latent vector are encoded at the second layer of the article neural network and the second layer of the user neural network respectively to obtain a second article latent vector and a second user latent vector. Next, the second article latent vector and the second user latent vector are transferred to the third layer of the article neural network and the third layer of the user neural network respectively. By analogy, an (N−1)^{th} article latent vector and an (N−1)^{th} user latent vector are encoded at an N^{th} layer of the article neural network and an N^{th} layer of the user neural network respectively, to obtain an N^{th} article latent vector and an N^{th} user latent vector. The obtained N^{th} article latent vector and the obtained N^{th} user latent vector are used as the target article latent vector and the target user latent vector.

In this way, because previous information can be refined at a higher layer of a neural network, more effective information can be generated, and accuracy of a recommendation result is improved.

In an optional embodiment, encoding the article content information and the user score information at the first layer of the article neural network and the first layer of the user neural network to obtain a first article latent vector and a first user latent vector includes performing linear transformation on the article content information and the user score information at the first layer of the article neural network and the first layer of the user neural network respectively, and performing nonlinear transformation respectively on the article content information and the user score information on which linear transformation has been performed to obtain the first article latent vector and the first user latent vector.

Further, the article content information and the user score information may be processed at the first layer of the multiple layers of perceptrons in two steps. First, performing linear transformation on the article content information and the user score information respectively, and next, performing nonlinear transformation on the article content information and the user score information respectively on which linear transformation has been performed to obtain the first article latent vector and the first user latent vector.

It should be noted that, the user score information is usually a high-dimensional sparse vector, and the high-dimensional sparse vector needs to be transformed into a low-dimensional dense vector by performing linear transformation at the first layer of the user neural network. In addition, at each layer of the multiple layers of perceptrons, linear transformation may be first performed, and nonlinear transformation may be subsequently performed on inputted information. This is not limited in this embodiment of this application.

In an optional embodiment, a tan h function is used as a nonlinear activation function at each layer of the article neural network and each layer of the user neural network.

It should be noted that, the tan h function is used only in an implementation, and in this embodiment of this application, another function may alternatively be used as a nonlinear activation function. This is not limited in this embodiment of this application.

In an optional embodiment, the method further includes obtaining newly added user score information of a second user of the at least one user, where the newly added user score information is a newly added score of the second user for a first article of the at least one article, updating user score information of the second user according to the newly added user score information, re-encoding the updated user score information of the second user using the user neural network to obtain a new target user latent vector, and calculating a new recommendation result for each user according to the target article latent vector and the new target user latent vector.

In an optional embodiment, the method further includes obtaining article content information of a newly added article, encoding the article content information of the newly added article using the article neural network to obtain a target article latent vector of the newly added article, and calculating a recommendation result for each user according to the target article latent vector of the newly added article and the target user latent vector.

In an optional embodiment, the method further includes obtaining newly added user score information of a third user of the at least one user, where the newly added user score information is score information of the third user for the newly added article, updating user score information of the third user for a second article of the at least one article, where a target article latent vector of the second article and the target article latent vector of the newly added article are most similar, re-encoding updated user score information of the third user using the user neural network, to obtain a new target user latent vector, and calculating a new recommendation result for each user according to the target article latent vector and the new target user latent vector.

Further, when a new article and/or new user score information is added to a system, a corresponding recommendation result may be obtained using the newly added information on the dual networks. Further, there may be the following three cases.

(1) Score information of a user for a known article is added. In this case, score information of the user needs to be directly updated, and re-encoding is performed using the user neural network that has been trained to recalculate a recommendation result.

(2) A new article is added. In this case, article content information of the newly added article needs to be obtained, and the article content information of the newly added article is encoded using the article neural network that has been trained to obtain a target article latent vector of the newly added article to recalculate a recommendation result.

(3) Score information of a user for the newly added article is added. In this case, the target article latent vector of the newly added article needs to be first obtained, and score information of an article of known articles is subsequently updated, where a latent vector of the article and a latent vector of the newly added article are most similar to perform re-encoding for the user according to new score information to calculate a recommendation result.

In a specific implementation, it is assumed that there are m users and n articles, and score information of an i^{th} user for a q^{th} article is newly added, where i is less than or equal to m, and q is greater than n. If a latent vector of a k^{th} article and a latent vector of the newly added article are most similar, score information Rᵢₖ of the k^{th} article may be updated to Rᵢₖ+1 to obtain new score information of the i^{th} user, and re-encoding is performed for the user using the user neural network to obtain a new recommendation result.

In an optional embodiment, before the obtaining article content information of at least one article and user score information of at least one user, the method further includes pre-training the article neural network using an encoding result of a stacked autoencoder SDAE, and pre-training the user neural network using a random parameter.

In an optional embodiment, before the obtaining article content information of at least one article and user score information of at least one user, the method further includes performing optimization training on the article neural network and the user neural network using a mini-batch dual gradient descent method.

Further, before the recommendation result is obtained, the article neural network and the user neural network may be first trained. A collaborative training method is used in this embodiment of this application, and includes two steps of pre-training and optimization. In a pre-training process, the article neural network is pre-trained using an encoding result of a stacked autoencoder SDAE, and the user neural network is pre-trained using a random parameter. In an optimization process, optimization training is performed on the article neural network and the user neural network using a mini-batch dual gradient descent method.

In this way, two groups of gradients are obtained respectively for an article and a user using a loss value obtained using a target function, and the two groups of gradients are transferred back to corresponding networks respectively. Due to a multilayer interaction network design, training of each network affects another network, and two neural networks are simultaneously trained using a collaborative network training algorithm to improve optimization efficiency.

In addition, when new information is constantly added and is accumulated to a particular amount, a system needs to update the network parameters of the article neural network and the user neural network to make a more accurate prediction. For newly added information, a training method of mini-batch dual gradient descent may be used, to shorten a network parameter update time.

In an optional embodiment, the performing optimization training on the article neural network and the user neural network using a mini-batch dual gradient descent method includes calculating a dot product of a p^{th} article latent vector and a p^{th} user latent vector as an output result of a p^{th}-layer perceptron of the N layers of perceptrons, where p is an integer greater than or equal to 1 and less than or equal to N, combining output results of all of the N layers of perceptrons, and optimizing network parameters of the article neural network and the user neural network by comparing the output result with the user score information.

Further, for each layer of the multiple layers of perceptrons, an output result may be generated. For example, for a p^{th} layer, a dot product of a p^{th} article latent vector and a p^{th} user latent vector is calculated as an output result of the p^{th} layer. In this way, output results of all layers may be combined to optimize the network parameters.

It should be noted that, encoding results of different layers of the multiple layers of perceptrons are complementary. In one aspect, a vector generated at a lower layer close to an input end may retain more information. In another aspect, information may be refined at a higher layer of a neural network. In this way, a generated vector is usually more effective. Therefore, complementarity may be used by coupling multiple layers to effectively improve prediction precision.

Optionally, combining the output results of all of the N layers of perceptrons includes adding the output results of all the layers of perceptrons.

In an optional embodiment, a target function of the optimization training is:

$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} ,$$

where R_{m×n} is a scoring matrix generated according to the user score information, and is used to indicate a score of each of m users for each of n articles, Rᵢⱼ is score information of an i^{th} user for a j^{th} article, xⱼ is content information of the j^{th} article, f is the article neural network, g is the user neural network, Wᵥ is a parameter of the article neural network, Wᵤ is a parameter of the user neural network, vⱼ=f(xⱼ;Wᵥ) is an article latent vector of the j^{th} article, uᵢ=g(V·r̅ᵢ;Wᵤ) is a user latent vector of the i^{th} user, rᵢ is a column vector generated using an i^{th} row of R_{m×n}, r̅ᵢ is a unit vector obtained using rᵢ, R̅ᵢⱼ is a j^{th} element in r̅ᵢ, V=f(X;Wᵥ), X is a matrix formed by article content information of the n articles, m, n, i, and j are all integers greater than or equal to 1, i is greater than or equal to 1 and is less than or equal to m, and j is greater than or equal to 1 and is less than or equal to n.

Further, it is assumed that there are m users and n articles, and i and j are respectively used to indicate indexes. xⱼ is used to indicate content information of a j^{th} article. A scoring matrix R_{m×n} includes historical information of scores of all known users for articles. When is 1, it indicates that there is a positive relationship between an i^{th} user and the j^{th} article. When Rᵢⱼ is 0, it indicates that there is a negative relationship between an i^{th} user and the j^{th} article, or that a relationship between an i^{th} user and the j^{th} article is unknown. In this embodiment of this application, latent vectors having a same dimension are obtained for a user and an article respectively by means of encoding using the article content information X and the scoring matrix R_{m×n}, a latent vector of each user is uᵢ=g(Vrᵢ;Wᵤ), and a latent vector of each article is vⱼ=f(xⱼ;Wᵥ). Finally, a dot product of the user latent vector and the article latent vector is calculated, and a calculated result is compared with an actual value Rᵢⱼ to optimize the network parameters.

In conclusion, according to the recommendation result generation method in this embodiment of this application, both the article content information and a user scoring matrix are used, prediction precision of a scoring matrix is intensively improved, and a target function is simplified to an expression. According to this method, two deep networks are simultaneously trained using a collaborative network training algorithm, an article latent vector may be used for both a new article and an existing article, and a recommendation score of any user for any article is calculated, to improve user experience.

FIG. 2 is a schematic flowchart of another recommendation result generation method 200 according to an embodiment of this application. The method 200 in this embodiment of this application may be implemented by any computing node, and this is not limited in this embodiment of this application.

In step S201, article content information of at least one article and user score information of at least one user for the at least one article are used as inputs of an article neural network and a user neural network respectively.

In step S202, the article content information and the user score information are converted to vectors on the article neural network and the user neural network respectively.

In step S203, linear transformation is performed on the article content information and the user score information that are in a form of a vector at the first layer of the article neural network and the first layer of the user neural network respectively.

In step S204, at the first layer of the article neural network and the first layer of the user neural network, nonlinear transformation is performed respectively on the article content information on which linear transformation has been performed and the user score information on which linear transformation has been performed to obtain a first article latent vector and a first user latent vector.

In step S205, a dot product of the first article latent vector and the first user latent vector is calculated.

In step S206, linear transformation is performed on the first article latent vector and the first user latent vector at the second layer of the article neural network and the second layer of the user neural network respectively.

In step S207, at the second layer of the article neural network and the second layer of the user neural network, nonlinear transformation is performed respectively on the first article latent vector on which linear transformation has been performed and the first user latent vector on which linear transformation has been performed to obtain a second article latent vector and a second user latent vector.

In step S208, a dot product of the second article latent vector and the second user latent vector is calculated.

In step S209, linear transformation is performed on the second article latent vector and the second user latent vector at the third layer of the article neural network and the third layer of the user neural network respectively.

In step S210, at the third layer of the article neural network and the third layer of the user neural network, nonlinear transformation is performed respectively on the second article latent vector on which linear transformation has been performed and the second user latent vector on which linear transformation has been performed to obtain a third article latent vector and a third user latent vector.

In step S211, a dot product of the third article latent vector and the third user latent vector is calculated.

In step S212, the dot product of the first article latent vector and the first user latent vector, the dot product of the second article latent vector and the second user latent vector, and the dot product of the third article latent vector and the third user latent vector are combined, a combined result is compared with an actual value, and network parameters are optimized using a target function

$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} .$$

R_{m×n} is a scoring matrix generated according to the user score information, and is used to indicate a score of each of m users for each of n articles, Rᵢⱼ is score information of an i^{th} user for a j^{th} article, xⱼ is content information of the j^{th} article, f is the article neural network, g is the user neural network, Wᵥ is a parameter of the article neural network, Wᵤ is a parameter of the user neural network, vⱼ=f(xⱼ;Wᵥ) is an article latent vector of the j^{th} article, uᵢ=g(V·r̅ᵢ; Wᵤ) is a user latent vector of the i^{th} user, rᵢ is a column vector generated using an i^{th} row of R_{m×n}, r̅ᵢ is a unit vector obtained using rᵢ, R̅ᵢⱼ is a j^{th} element in r̅ᵢ, V=f(X;Wᵥ), X is a matrix formed by article content information of the n articles, m, n, i, and j are all integers greater than or equal to 1, i is greater than or equal to 1 and is less than or equal to m, and j is greater than or equal to 1 and is less than or equal to n.

It should be noted that, after optimization, the method 200 may include all the steps and procedures in the method 100 to obtain a recommendation result. Details are not described herein again.

According to the recommendation result generation method in this embodiment of this application, the article content information and the user score information are encoded using the article neural network and the user neural network respectively to obtain the target article latent vector and the target user latent vector to calculate the recommendation result. In this way, the article content information and the user score information can be fully utilized to improve accuracy of a recommendation result to improve user experience.

It should be noted that, sequence numbers of the foregoing processes do not indicate an execution sequence, and an execution sequence of processes shall be determined according to functions and internal logic thereof, and shall constitute no limitation on an implementation process of the embodiments of this application.

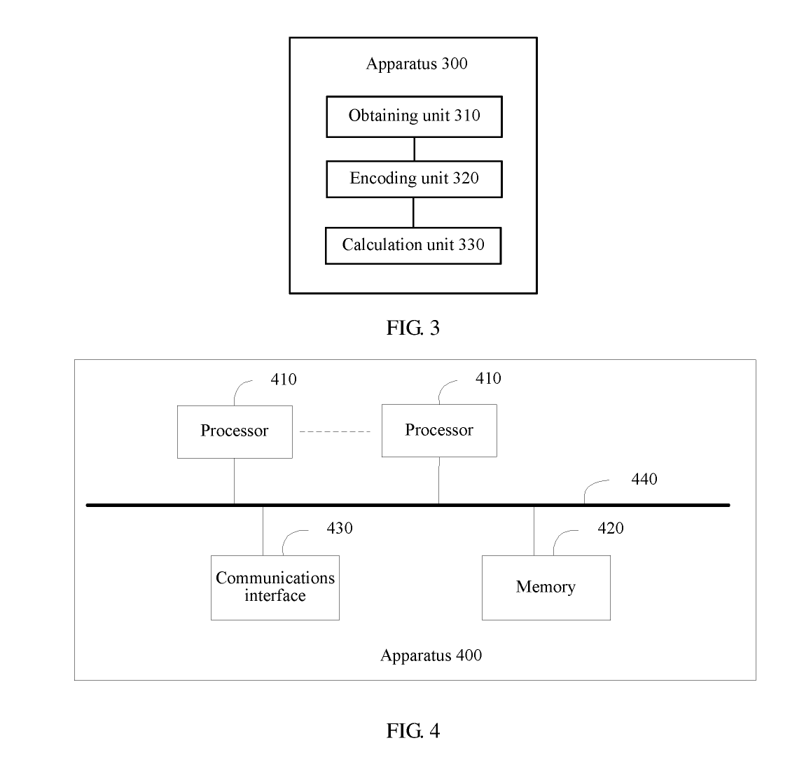

The recommendation result generation method according to the embodiments of this application is described in detail above with reference to FIG. 1 and FIG. 2. A recommendation result generation apparatus according to the embodiments of this application is described in detail below with reference to FIG. 3 and FIG. 4.

FIG. 3 shows a recommendation result generation apparatus 300 according to an embodiment of this application. The apparatus 300 includes an obtaining unit 310 configured to obtain article content information of at least one article and user score information of at least one user, where user score information of a first user of the at least one user includes a historical score of the first user for the at least one article, an encoding unit 320 configured to encode the article content information and the user score information using an article neural network and a user neural network respectively to obtain a target article latent vector of each of the at least one article and a target user latent vector of each of the at least one user, and a calculation unit 330 configured to calculate a recommendation result for each user according to the target article latent vector and the target user latent vector.

According to the recommendation result generation apparatus 300 in this embodiment of this application, the article content information and the user score information are encoded using the article neural network and the user neural network respectively to obtain the target article latent vector and the target user latent vector to calculate the recommendation result. In this way, the article content information and the user score information can be fully utilized to improve accuracy of a recommendation result to improve user experience.

Optionally, N layers of perceptrons are used as a basic architecture of the article neural network and the user neural network, and both the article neural network and the user neural network have N layers. The encoding unit 320 is further configured to encode the article content information and the user score information at the first layer of the article neural network and the first layer of the user neural network to obtain a first article latent vector and a first user latent vector, transfer the first article latent vector and the first user latent vector to the second layer of the article neural network and the second layer of the user neural network respectively to perform encoding, encode a (k−1)^{th} article latent vector and a (k−1)^{th} user latent vector at a k^{th} layer of the article neural network and a k^{th} layer of the user neural network respectively, to obtain a k^{th} article latent vector and a k^{th} user latent vector, transfer the k^{th} article latent vector and the k^{th} user latent vector to a (k+1)^{th} layer of the article neural network and a (k+1)^{th} layer of the user neural network respectively to perform encoding, encode an (N−1)^{th} article latent vector and an (N−1)^{th} user latent vector at an N^{th} layer of the article neural network and an N^{th} layer of the user neural network respectively to obtain an N^{th} article latent vector and an N^{th} user latent vector, and set the N^{th} article latent vector and the N^{th} user latent vector as the target article latent vector and the target user latent vector respectively, where N is an integer greater than or equal to 1, and k is an integer greater than 1 and less than N.

Optionally, the encoding unit 320 is further configured to perform linear transformation on the article content information and the user score information at the first layer of the article neural network and the first layer of the user neural network respectively, and perform nonlinear transformation respectively on the article content information and the user score information on which linear transformation has been performed to obtain the first article latent vector and the first user latent vector.

Optionally, a tan h function is used as a nonlinear activation function at each layer of the article neural network and each layer of the user neural network.

Optionally, the obtaining unit 310 is further configured to obtain newly added user score information of a second user of the at least one user, where the newly added user score information is a newly added score of the second user for a first article of the at least one article. The apparatus 300 further includes a first update unit (not shown) configured to update user score information of the second user according to the newly added user score information. The encoding unit 320 is further configured to re-encode the updated user score information of the second user using the user neural network to obtain a new target user latent vector. The calculation unit 330 is further configured to calculate a new recommendation result for each user according to the target article latent vector and the new target user latent vector.

Optionally, the obtaining unit 310 is further configured to obtain article content information of a newly added article. The encoding unit 320 is further configured to encode the article content information of the newly added article using the article neural network to obtain a target article latent vector of the newly added article. The calculation unit 330 is further configured to calculate a recommendation result for each user according to the target article latent vector of the newly added article and the target user latent vector.

Optionally, the obtaining unit 310 is further configured to obtain newly added user score information of a third user of the at least one user, where the newly added user score information is score information of the third user for the newly added article. The apparatus 300 further includes a second update unit (not shown) configured to update user score information of the third user for a second article of the at least one article, where a target article latent vector of the second article and the target article latent vector of the newly added article are most similar. The encoding unit 320 is further configured to re-encode updated user score information of the third user using the user neural network to obtain a new target user latent vector. The calculation unit 330 is further configured to calculate a new recommendation result for each user according to the target article latent vector and the new target user latent vector.

Optionally, the apparatus 300 further includes a pre-training unit (not shown) configured to, before the article content information of the at least one article and the user score information of the at least one user are obtained, pre-train the article neural network using an encoding result of an SDAE, and pre-train the user neural network using a random parameter.

Optionally, the apparatus 300 further includes an optimization unit (not shown) configured to, before the article content information of the at least one article and the user score information of the at least one user are obtained, perform optimization training on the article neural network and the user neural network using a mini-batch dual gradient descent method.

Optionally, the calculation unit 330 is further configured to calculate a dot product of a p^{th} article latent vector and a p^{th} user latent vector as an output result of a p^{th}-layer perceptron of the N layers of perceptrons, where p is an integer greater than or equal to 1 and less than or equal to N, combine output results of all of the N layers of perceptrons, and optimize network parameters of the article neural network and the user neural network by comparing the output results with the user score information.

Optionally, a target function of the optimization training is

$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} ,$$

where R_{m×n} is a scoring matrix generated according to the user score information, and is used to indicate a score of each of m users for each of n articles, Rᵢⱼ is score information of an i^{th} user for a i^{th} article, xⱼ is content information of the j^{th} article, f is the article neural network, g is the user neural network, Wᵥ is a parameter of the article neural network, Wᵤ is a parameter of the user neural network, vⱼ=f(xⱼ;Wᵥ) is an article latent vector of the j^{th} article, uᵢ=g(V·r̅ᵢ; Wᵤ) is a user latent vector of the i^{th} user, rᵢ is a column vector generated using an i^{th} row of R_{m×n}, r̅ᵢ is a unit vector obtained using rᵢ, R̅ᵢⱼ is a j^{th} element in r̅ᵢ, V=f(X;Wᵥ), X is a matrix formed by article content information of the n articles, m, n, i, and j are all integers greater than or equal to 1, i is greater than or equal to 1 and is less than or equal to m, and j is greater than or equal to 1 and is less than or equal to n.

It should be noted that the apparatus 300 is represented in a form of a functional unit. The term “unit” herein may be an application-specific integrated circuit (ASIC), an electronic circuit, a processor (for example, a shared processor, a dedicated processor) configured to execute one or more software or firmware programs, a memory, a combined logical circuit, and/or another suitable component that supports the described functions. In an optional example, a person skilled in the art may understand that, the apparatus 300 may be further any computing node. The apparatus 300 may be configured to perform the procedures and/or steps in the method 100 of the foregoing embodiment. Details are not described herein again to avoid repetition.

FIG. 4 shows another recommendation result generation apparatus 400 according to an embodiment of this application. The apparatus 400 includes at least one processor 410, a memory 420, and a communications interface 430. The at least one processor 410, the memory 420, and the communications interface 430 are all connected using a bus 440.

The memory 420 is configured to store a computer executable instruction.

The at least one processor 410 is configured to execute the computer executable instruction stored in the memory 420 such that the apparatus 400 can exchange data with another apparatus using the communications interface 430 to perform the recommendation result generation method provided in the method embodiments.

The at least one processor 410 is configured to perform the following operations of obtaining content information of at least one article and user score information of at least one user, where user score information of a first user of the at least one user includes a historical score of the first user for the at least one article, encoding the article content information and the user score information using an article neural network and a user neural network respectively to obtain a target article latent vector of each of the at least one article and a target user latent vector of each of the at least one user, and calculating a recommendation result for each user according to the target article latent vector and the target user latent vector.

Optionally, N layers of perceptrons are used as a basic architecture of the article neural network and the user neural network, and both the article neural network and the user neural network have N layers. The at least one processor 410 is further configured to encode the article content information and the user score information at the first layer of the article neural network and the first layer of the user neural network, to obtain a first article latent vector and a first user latent vector, transfer the first article latent vector and the first user latent vector to the second layer of the article neural network and the second layer of the user neural network respectively to perform encoding, encode a (k−1)^{th} article latent vector and a (k−1)^{th} user latent vector at a k^{th} layer of the article neural network and a k^{th} layer of the user neural network respectively to obtain a k^{th} article latent vector and a k^{th} user latent vector, transfer the k^{th} article latent vector and the k^{th} user latent vector to a (k+1)^{th} layer of the article neural network and a (k+1)^{th} layer of the user neural network respectively to perform encoding, encode an (N−1)^{th} article latent vector and an (N−1)^{th} user latent vector at an N^{th} layer of the article neural network and an N^{th} layer of the user neural network respectively to obtain an N^{th} article latent vector and an N^{th} user latent vector, and set the N^{th} article latent vector and the N^{th} user latent vector as the target article latent vector and the target user latent vector respectively, where N is an integer greater than or equal to 1, and k is an integer greater than 1 and less than N.

Optionally, the at least one processor 410 is further configured to perform linear transformation on the article content information and the user score information at the first layer of the article neural network and the first layer of the user neural network respectively, and perform nonlinear transformation respectively on the article content information and the user score information on which linear transformation has been performed to obtain the first article latent vector and the first user latent vector.

Optionally, a tan h function is used as a nonlinear activation function at each layer of the article neural network and each layer of the user neural network.

Optionally, the at least one processor 410 is further configured to obtain newly added user score information of a second user of the at least one user, where the newly added user score information is a newly added score of the second user for a first article of the at least one article, update user score information of the second user according to the newly added user score information, re-encode the updated user score information of the second user using the user neural network, to obtain a new target user latent vector, and calculate a new recommendation result for each user according to the target article latent vector and the new target user latent vector.

Optionally, the at least one processor 410 is further configured to obtain article content information of a newly added article, encode the article content information of the newly added article using the article neural network, to obtain a target article latent vector of the newly added article, and calculate a recommendation result for each user according to the target article latent vector of the newly added article and the target user latent vector.

Optionally, the at least one processor 410 is further configured to obtain newly added user score information of a third user of the at least one user, where the newly added user score information is score information of the third user for the newly added article, update user score information of the third user for a second article of the at least one article, where a target article latent vector of the second article and the target article latent vector of the newly added article are most similar, re-encode updated user score information of the third user using the user neural network to obtain a new target user latent vector, and calculate a new recommendation result for each user according to the target article latent vector and the new target user latent vector.

Optionally, the at least one processor 410 is further configured to, before obtaining the article content information of the at least one article and the user score information of the at least one user, pre-train the article neural network using an encoding result of a stacked autoencoder SDAE, and pre-train the user neural network using a random parameter.

Optionally, the at least one processor 410 is further configured to, before obtaining the article content information of the at least one article and the user score information of the at least one user, perform optimization training on the article neural network and the user neural network using a mini-batch dual gradient descent method.

Optionally, the at least one processor 410 is further configured to calculate a dot product of a p^{th} article latent vector and a p^{th} user latent vector as an output result of a p^{th}-layer perceptron of the N layers of perceptrons, where p is an integer greater than or equal to 1 and less than or equal to N, combine output results of all of the N layers of perceptrons, and optimize network parameters of the article neural network and the user neural network by comparing the output results with the user score information.

Optionally, a target function of the optimization training is

$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} ,$$

where R_{m×n} is a scoring matrix generated according to the user score information, and is used to indicate a score of each of m users for each of n articles, Rᵢⱼ is score information of an i^{th} user for a j^{th} article, xⱼ is content information of the j^{th} article, f is the article neural network, g is the user neural network, Wᵥ is a parameter of the article neural network, Wᵤ is a parameter of the user neural network, vⱼ=f(xⱼ;Wᵥ) is an article latent vector of the j^{th} article, uᵢ=g(Vr̅ᵢ;Wᵤ) is a user latent vector of the i^{th} user, rᵢ is a column vector generated using an i^{th} row of R_{m×n}, r̅ᵢ is a unit vector obtained using rᵢ, R̅ᵢⱼ is a j^{th} element in r̅ᵢ, V=f(X;Wᵥ) is a matrix formed by article content information of the n articles, m, n, i, and j are all integers greater than or equal to 1, i is greater than or equal to 1 and is less than or equal to m, and j is greater than or equal to 1 and is less than or equal to n.

It should be noted that, the apparatus 400 may be further a computing node, and may be configured to perform the steps and/or the procedures corresponding to the method 100 of the foregoing embodiment.

It should be understood that in the embodiments of this application, the at least one processor may include different types of processors, or include processors of a same type. The processor may be any component with a computing processing capability, such as a central processing unit (CPU), an Advanced Reduced Instruction Set Computing (RISC) Machine (ARM) processor, a field programmable gate array (FPGA), or a dedicated processor. In an optional implementation, the at least one processor may be integrated as a many-core processor.

The memory 420 may be any one or any combination of the following storage mediums, such as a random access memory (RAM), a read-only memory (ROM), a nonvolatile memory (NVM), a solid state drive (SSD), a mechanical hard disk, a disk, and a disk array.

The communications interface 430 is used by the apparatus to exchange data with another device. The communications interface 430 may be any one or any combination of the following components with a network access function, such as a network interface (for example, an Ethernet interface) and a wireless network interface card.

The bus 440 may include an address bus, a data bus, a control bus, and the like. For ease of denotation, the bus 440 is represented using a thick line in FIG. 4. The bus 440 may be any one or any combination of the following components used for wired data transmission, such as an Industry Standard Architecture (ISA) bus, a Peripheral Component Interconnect (PCI) bus, and an Extended ISA (EISA) bus.

In an implementation process, steps in the foregoing methods can be implemented using a hardware integrated logical circuit in the at least one processor 410, or using instructions in a form of software. The steps of the method disclosed with reference to the embodiments of this application may be directly performed by a hardware processor, or may be performed using a combination of hardware in the processor and a software module. A software module may be located in a mature storage medium in the art, such as a RAM, a flash memory, a ROM, a programmable ROM (PROM), an electrically erasable PROM (EEPROM), a register, or the like. The storage medium is located in the memory 420, and the at least one processor 410 reads instructions in the memory 420 and completes the steps in the foregoing methods in combination with hardware of the processor 410. To avoid repetition, details are not described herein again.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or modules may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present application. The foregoing storage medium includes any medium that can store program code, such as a universal serial bus (USB) flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A recommendation result generation method, comprising:
obtaining article content information of at least one article and user score information of at least one user, user score information of a first user of the at least one user comprising a historical score of the first user for the at least one article;
encoding the article content information and the user score information of the at least one user using an article neural network and a user neural network respectively to obtain a target article latent vector of each of the at least one article and a target user latent vector of each of the at least one user;
calculating a recommendation result for each user according to the target article latent vector and the target user latent vector; and
providing the recommendation result to each user.

2. The method of claim 1, wherein N layers of perceptrons are used as a basic architecture of the article neural network and the user neural network, and encoding the article content information and the user score information comprising:
encoding the article content information and the user score information at a first layer of the article neural network and a first layer of the user neural network to obtain a first article latent vector and a first user latent vector;
transferring the first article latent vector and the first user latent vector to a second layer of the article neural network and a second layer of the user neural network respectively to perform encoding;
encoding a (k−1)^{th} article latent vector and a (k−1)^{th} user latent vector at a k^{th} layer of the article neural network and a k^{th} layer of the user neural network respectively to obtain a k^{th} article latent vector and a k^{th} user latent vector;
transferring the k^{th} article latent vector and the k^{th} user latent vector to a (k+1)^{th} layer of the article neural network and a (k+1)^{th} layer of the user neural network respectively to perform encoding;
encoding an (N−1)^{th} article latent vector and an (N−1)^{th} user latent vector at an N^{th} layer of the article neural network and an N^{th} layer of the user neural network respectively to obtain an N^{th} article latent vector and an N^{th} user latent vector; and
setting the N^{th} article latent vector and the N^{th} user latent vector as the target article latent vector and the target user latent vector respectively, N comprising an integer greater than or equal to one, and k comprising an integer greater than one and less than N.

3. The method of claim 2, wherein encoding the article content information and the user score information at the first layer of the article neural network and the first layer of the user neural network comprises:
performing linear transformation on the article content information and the user score information at the first layer of the article neural network and the first layer of the user neural network respectively; and
performing nonlinear transformation respectively on the article content information and the user score information on which the linear transformation has been performed to obtain the first article latent vector and the first user latent vector.

4. The method of claim 1, further comprising:
obtaining newly added user score information of a second user of the at least one user, the newly added user score information comprising a newly added score of the second user for a first article of the at least one article;
updating user score information of the second user according to the newly added user score information;
re-encoding updated user score information of the second user using the user neural network to obtain a new target user latent vector; and
calculating a new recommendation result for each user according to the target article latent vector and the new target user latent vector.

5. The method of claim 1, further comprising:
obtaining article content information of a newly added article;
encoding the article content information of the newly added article using the article neural network to obtain a target article latent vector of the newly added article; and
calculating a recommendation result for each user according to the target article latent vector of the newly added article and the target user latent vector.

6. The method of claim 5, further comprising:
obtaining newly added user score information of a third user of the at least one user, the newly added user score information comprising score information of the third user for the newly added article;
updating user score information of the third user for a second article of the at least one article, a target article latent vector of the second article and the target article latent vector of the newly added article being most similar;
re-encoding updated user score information of the third user using the user neural network to obtain a new target user latent vector; and
calculating a new recommendation result for each user according to the target article latent vector and the new target user latent vector.

7. The method of claim 1, wherein before obtaining the article content information of the at least one article and the user score information of the at least one user, the method further comprises:
pre-training the article neural network using an encoding result of a stacked denoising autoencoder (SDAE); and
pre-training the user neural network using a random parameter.

8. The method of claim 2, wherein before obtaining the article content information of the at least one article and the user score information of the at least one user, the method further comprises performing optimization training on the article neural network and the user neural network using a mini-batch dual gradient descent method.

9. The method of claim 8, wherein performing the optimization training on the article neural network and the user neural network using the mini-batch dual gradient descent method comprises:
calculating a dot product of a p^{th} article latent vector and a p^{th} user latent vector as an output result of a p^{th}-layer perceptron of the N layers of perceptrons, p comprising an integer greater than or equal to one and less than or equal to N;
combining output results of all of the N layers of perceptrons; and
optimizing network parameters of the article neural network and the user neural network by comparing combined output results with the user score information of the at least one user.

10. The method of claim 8, wherein a target function of the optimization training comprises:
$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} ,$$
R_{m×n} comprising a scoring matrix generated according to the user score information of the at least one user and indicates a score of each of m users for each of n articles, Rᵢⱼ comprising score information of an i^{th} user for a j^{th} article, xⱼ comprising content information of the j^{th} article, f comprising the article neural network, g comprising the user neural network, Wᵥ comprising a parameter of the article neural network, Wᵤ comprising a parameter of the user neural network, vⱼ=f(xⱼ;Wᵥ) comprising an article latent vector of the j^{th} article, uᵢ=g(V·r̅ᵢ;Wᵤ) comprising a user latent vector of the i^{th} user, rᵢ comprising a column vector generated using an i^{th} row of R_{m×n}, r̅ᵢ comprising a unit vector obtained using rᵢ, R̅ᵢⱼ comprising a j^{th} element in r̅ᵢ, V=f(X;Wᵥ), X comprising a matrix formed by article content information of the n articles, m, n, i, and j being all integers greater than or equal to one, i being greater than or equal to one and less than or equal to m, and j being greater than or equal to one and less than or equal to n.

11. A recommendation result generation apparatus, comprising:
a memory configured to store a computer executable instruction; and
at least one processor coupled to the memory, the computer executable instruction causing the at least one processor to be configured to:
obtain article content information of at least one article and user score information of at least one user, user score information of a first user of the at least one user comprising a historical score of the first user for the at least one article;
encode the article content information and the user score information of the at least one user using an article neural network and a user neural network respectively to obtain a target article latent vector of each of the at least one article and a target user latent vector of each of the at least one user;
calculate a recommendation result for each user according to the target article latent vector and the target user latent vector; and
provide the recommendation result to each user.

12. The apparatus of claim 11, wherein N layers of perceptrons are used as a basic architecture of the article neural network and the user neural network, and the computer executable instruction further causing the at least one processor to be configured to:
encode the article content information and the user score information at a first layer of the article neural network and a first layer of the user neural network to obtain a first article latent vector and a first user latent vector;
transfer the first article latent vector and the first user latent vector to a second layer of the article neural network and a second layer of the user neural network respectively to perform encoding;
encode a (k−1)^{th} article latent vector and a (k−1)^{th} user latent vector at a k^{th} layer of the article neural network and a k^{th} layer of the user neural network respectively to obtain a k^{th} article latent vector and a k^{th} user latent vector;
transfer the k^{th} article latent vector and the k^{th} user latent vector to a (k+1)^{th} layer of the article neural network and a (k+1)^{th} layer of the user neural network respectively to perform encoding;
encode an (N−1)^{th} article latent vector and an (N−1)^{th} user latent vector at an N^{th} layer of the article neural network and an N^{th} layer of the user neural network respectively to obtain an N^{th} article latent vector and an N^{th} user latent vector; and
set the N^{th} article latent vector and the N^{th} user latent vector as the target article latent vector and the target user latent vector respectively, N comprising an integer greater than or equal to one, and k comprising an integer greater than one and less than N.

13. The apparatus of claim 12, wherein the computer executable instruction further causes the at least one processor to be configured to:
perform linear transformation on the article content information and the user score information at the first layer of the article neural network and the first layer of the user neural network respectively; and
perform nonlinear transformation respectively on the article content information and the user score information on which the linear transformation has been performed to obtain the first article latent vector and the first user latent vector.

14. The apparatus of claim 11, wherein the computer executable instruction further causes the at least one processor to be configured to:
obtain newly added user score information of a second user of the at least one user, the newly added user score information comprising a newly added score of the second user for a first article of the at least one article;
update user score information of the second user according to the newly added user score information;
re-encode the updated user score information of the second user using the user neural network to obtain a new target user latent vector; and
calculate a new recommendation result for each user according to the target article latent vector and the new target user latent vector.

15. The apparatus of claim 11, wherein the computer executable instruction further causes the at least one processor to be configured to:
obtain article content information of a newly added article;
encode the article content information of the newly added article using the article neural network to obtain a target article latent vector of the newly added article; and
calculate a new recommendation result for each user according to the target article latent vector of the newly added article and the target user latent vector.

16. The apparatus of claim 15, wherein the computer executable instruction further causes the at least one processor to be configured to:
obtain newly added user score information of a third user of the at least one user, the newly added user score information comprising score information of the third user for the newly added article;
update user score information of the third user for a second article of the at least one article, a target article latent vector of the second article and the target article latent vector of the newly added article being most similar;
re-encode updated user score information of the third user using the user neural network to obtain a new target user latent vector; and
calculate a new recommendation result for each user according to the target article latent vector and the new target user latent vector.

17. The apparatus of claim 11, wherein the computer executable instruction further causes the at least one processor to be configured to:
pre-train the article neural network using an encoding result of a stacked denoising autoencoder (SDAE) before the article content information of the at least one article and the user score information of the at least one user are obtained; and
pre-train the user neural network using a random parameter.

18. The apparatus of claim 12, wherein before the article content information of the at least one article and the user score information of the at least one user are obtained, the computer executable instruction further causes the at least one processor to be configured to perform optimization training on the article neural network and the user neural network using a mini-batch dual gradient descent method.

19. The apparatus of claim 18, wherein the computer executable instruction further causes the at least one processor to be configured to:
calculate a dot product of a p^{th} article latent vector and a p^{th} user latent vector as an output result of a p^{th}-layer perceptron of the N layers of perceptrons, p comprising an integer greater than or equal to one and less than or equal to N;
combine output results of all of the N layers of perceptrons; and
optimize network parameters of the article neural network and the user neural network by comparing combined output results with the user score information of the at least one user.

20. The apparatus of claim 18, wherein a target function of the optimization training comprises:
$${min}_{{W}_{u} , {W}_{v}} {\sum }_{i} {\sum }_{j} {c}_{ij} {‖ {\overline{R}}_{ij} - 〈 f ( {x}_{j} ; {W}_{v} ) , g ( V \cdot \overline{{r}_{i}} ; {W}_{u} ) 〉 ‖}^{2} ,$$
R_{m×n} comprising a scoring matrix generated according to the user score information of the at least one user and indicates a score of each of m users for each of n articles, Rᵢⱼ comprising score information of an i^{th} user for a j^{th} article, xⱼ comprising content information of the j^{th} article, f comprising the article neural network, g comprising the user neural network, Wᵥ comprising a parameter of the article neural network, Wᵤ comprising a parameter of the user neural network, vⱼ=f(xⱼ;Wᵥ) comprising an article latent vector of the j^{th} article, uᵢ=g(V·r̅ᵢ;Wᵤ) comprising a user latent vector of the i^{th} user, rᵢ comprising a column vector generated using an i^{th} row of R_{m×n}, r̅ᵢ comprising a unit vector obtained using comprising a j^{th} element in r̅ᵢ, V=f(X;Wᵥ), X comprising a matrix formed by article content information of the n articles, m, n, i, and j being all integers greater than or equal to one, i being greater than or equal to one and is less than or equal to m, and j being greater than or equal to one and is less than or equal to n.
